(19) United States
(12) Patent Application Publication
(10) Pub. No.: US 2024/0182711 A1
(43) Pub. Date: Jun. 6, 2024

(54) MULTILAYER POLYMER SHEET AND DENTAL APPLIANCE

(71) Applicant: SHANGHAI COHERZ TECHNOLOGY CO., LTD., Shanghai (CN)

(72) Inventor: Peng ZENG, Shanghai (CN)

(73) Assignee: SHANGHAI COHERZ TECHNOLOGY CO., LTD., Shanghai (CN)

(21) Appl. No.: 18/281,972

(22) PCT Filed: Mar. 31, 2022
(86) PCT No.: PCT/CN2022/084235

§ 371 Date: Sep. 14, 2023

(30) Foreign Application Priority Data
Oct. 9, 2021 (CN) 202111177815.3

(51) Int. Cl. C08L 77/02; A61C 7/08; B29C 48/14; B29C 48/21; B29C 48/88

(52) U.S. Cl. CPC C08L 77/02; B29C 48/146; B29C 48/21; B29C 48/88; A61C 7/08; B29C 2948/92647

(57) ABSTRACT

A multilayer polymer sheet and a dental appliance are provided. The multilayer polymer sheet includes an A-layer polymer and a B-layer polymer. The A-layer polymer is polyamide (PA), including the following groups: (1) 36 mol % to 40 mol % of 4,4-methylenebis(2-methylcyclohexylamine); (2) 36 mol % to 40 mol % of an aromatic dicarboxylic acid, which is 1,3-benzenedicarboxylic acid (IPA) and/or 1,4-benzenedicarboxylic acid (TPA); and (3) 20 mol % to 28 mol % of an alicyclic or aliphatic amino acid or lactam. The B-layer polymer is located between two layers of the A-layer polymer. The B-layer polymer is at least one selected from the group consisting of a thermoplastic polyurethane (TPU), an ethylene-vinyl acetate (EVA) copolymer, and a copolyester.

### CROSS REFERENCE TO THE RELATED APPLICATIONS

This application is the national phase entry of International Application No. PCT/CN2022/084235, filed on Mar. 31, 2022, which is based upon and claims priority to Chinese Patent Application No. 202111177815.3, filed on Oct. 9, 2021, the entire contents of which are incorporated herein by reference.

### TECHNICAL FIELD

The present disclosure belongs to the technical field of polymer materials, and relates to a multilayer polymer sheet and a dental appliance.

### BACKGROUND

Clear aligners are removable orthodontic appliances fabricated under computer-aided design and manufacturing, including a series of continuous transparent elastic devices which push teeth to move step by step in short step distance to achieve teeth alignment. These clear aligners are usually made from thermoplastic polymer sheets, by thermoforming, cutting and polishing process. During the treatment process, each pair of clear aligners will be replaced every 1 or 2 weeks and the entire treatment process can last for tens of months. At different stages of the treatment, only part of the teeth move, while other teeth acting as anchors. Under specified design rules, magnitude and duration of orthodontic force inside clear aligners are mainly determined by thermoplastic polymer sheets, so that the efficiency and satisfaction of orthodontic treatment will also largely depend on thermoplastic polymer sheets used.

Ideal sheets for clear aligners should offer excellent stress retention performance to provide enough force for tooth movement during 1 to 2 weeks of wearing. In addition, the sheets for clear aligners should be resistant to bite impact and stress cracking, avoiding destruction and breakage of the clear aligners during wearing. To provide aesthetic looks, the sheets for clear aligners should also be resistant to food contamination, and be easily cleaned and disinfected.

In response to the above requirements, materials for clear aligners have evolved from single-layer structure of single material to multilayer structure of multiple materials. The use of multiple materials in combination is conducive to making up for each component's deficiencies, thereby achieving excellent overall performance.

Align technology (Invisalign) was the first company to launch multilayer clear aligners. Patent U.S. Pat. No. 9,655,691B2 of Align technology discloses a dental appliance with a multilayer structure, including a hard copolyester inner layer, and first and second soft thermoplastic polyurethane (TPU) elastomer outer layers, where the hard copolyester inner layer is wrapped by the first and second soft TPU elastomer outer layers. The outer soft polyurethane (PU) elastomer has a flexural modulus of greater than 241.4 MPa, a Shore hardness range of 60 A to 85 D, and a thickness range of 25 μm to 100 μm. The first-layer and second-layer soft TPUs have a permanent compression set ratio of greater than 40% (70° C., 24 h), and the inner layer copolyester material has a stress degradation ratio of greater than 10% within 24 h at a humidity of 90% to 100%. According to clinical feedback, clear aligners made of this material is easy to be put on and taken off, and has a moderate orthodontic force and excellent wearing comfort. However, because a soft PU outer layer is used in the above structure, during use, the outer-layer material is easily damaged and stained, which affects the function and aesthetics.

Bay Materials, LLC (U.S. Pat. No. 10,549,511B2) provides a triple-layer polymer material with a sandwich structure, including two outer layers A and C and a middle layer B, where the outer layers A and C are thermoplastic copolyester and the middle layer B is a TPU elastomer. This structure can avoid staining of surface material while providing excellent stress retention performance. However, due to poor mechanical performance of the copolyester, the outer layer is prone to crazing and fracturing under stress. Studies have shown that clear aligners made of this material is also prone to surface damage, which may affect the use experience and may also affect the progress and the effect of the orthodontic treatment.

### SUMMARY

In order to solve the above problems and offer a prominent sheet material for a clear aligner, the present invention discloses a multilayer polymer sheet and a dental appliance.

Polyamide materials (PA, commonly known as nylon) have excellent mechanical and chemical performance, such as high tensile strength and excellent toughness, abrasion resistance, self-lubricating, oil resistance, and solvent resistance Common PA materials such as PA6, PA66, or PA12 are opaque or translucent materials, which are not suitable for preparation of clear aligners. In addition, these materials have high water absorption, with a saturation of water absorption rate as high as 9% to 12%; and the mechanical performance of these materials in humid environment is greatly reduced. Transparent PAs are amorphous or micro-crystalline polymers with special structures. Molecular chain of an amorphous transparent PA usually includes a side group or a ring structure, such that the regularity of molecular chains is destroyed to cause non-crystallization, which does not affect the transmission of visible light. The crystalline region of micro-crystalline PA can only reach a nano-scale, which also does not affect the transmission of visible light. The above two mechanisms can achieve the transparency of PA materials. Transparent PAs do not affect the aesthetics and thus can be considered for preparation of clear aligners. Transparent PAs of different formulas have much different properties.

The present disclosure has found that, when used as a sheet material for clear aligners, a modified PA material can provide excellent stress retention performance and abrasion resistance. The modified PA material includes: (1) 36 mol % to 40 mol % of 4,4-methylenebis(2-methylcyclohexylamine); (2) 36 mol % to 40 mol % of an aromatic dicarboxylic acid, which is IPA and/or TPA; and (3) 20 mol % to 28 mol % of an alicyclic or aliphatic amino acid or lactam. A multilayer material based on such modified PA material exhibits excellent stress retention performance and abrasion resistance. In addition, such a multilayer material has a low surface friction coefficient, which is conducive to the wearing and removal of clear aligners and provides a prominent orthodontic effect and wearing experience overall.

Specifically, the objective of the present disclosure is achieved by the following technical solutions.

The present disclosure provides a multilayer polymer sheet, including an A-layer polymer and a B-layer polymer, where
the A-layer polymer is an amorphous polyamide (PA);
the B-layer polymer is at least one selected from the group consisting of a TPU, an ethylene-vinyl acetate (EVA) copolymer, and a copolyester; and
the B-layer polymer is located between two layers of the A-layer polymer.

As an embodiment of the present disclosure, the A-layer polymer has a hardness range of 45 D to 87 D.

As an embodiment of the present disclosure, a structural unit of the A-layer polymer includes

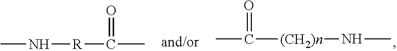

where R is a C₅-C₃₅ branched or cycloaliphatic hydrocarbon and n is 4 to 11.

As an embodiment of the present disclosure, the A-layer polymer is obtained through polymerization of the following substances: (1) 4,4-methylenebis(2-methylcyclohexylamine); (2) an aromatic dicarboxylic acid, which is 1,3-benzenedicarboxylic acid (IPA) and/or 1,4-benzenedicarboxylic acid (TPA); and (3) an alicyclic or aliphatic amino acid or lactam. An aliphatic amino acid has a general structural formula of NH₂—R—COOH, where R is a C₅-C₃₅ branched or cycloaliphatic hydrocarbon. A lactam has a general structural formula as follows:

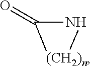

where n is 4 to 11.

As an embodiment of the present disclosure, the A-layer polymer has a water absorption rate of less than 5%, preferably less than 3.5%, and more preferably less than 3%.

As an embodiment of the present disclosure, the A-layer polymer has a relative viscosity of greater than 1.45, and the relative viscosity is tested in a 0.5% m-cresol solution at 20° C. according to an ISO 307 standard.

In some embodiments, the aromatic dicarboxylic acid is a mixture of IPA and TPA, where an amount of TPA is 50% or less of a total amount of the aromatic dicarboxylic acid. In the system of the present disclosure, IPA and TPA are used in combination to avoid excessive regularity of molecular chains, preventing crystallization which will affect the transparency of final product.

The amorphous PA available in the present disclosure may be prepared by a known method, such as melt polymerization and solution polymerization. An appropriate method for preparing the amorphous PA includes, but is not limited to, the following steps: Step 1: Preparation of an oligomer: TPA, IPA, or a mixture of TPA and IPA is subjected to a condensation reaction with an amino compound to obtain a diacid oligomer. The condensation reaction is usually conducted at a specified pressure in an inert gas under stirring. The condensation reaction is conducted at 260° C. to 310° C. and an atmospheric pressure or 30 bar. 0.8 mol to 2 mol of the amino compound is used per mol of the TPA, the IPA, or the mixture of TPA and IPA. Step 2: The alicyclic or aliphatic amino acid or lactam is added to the diacid oligomer at an atmospheric pressure, and a reaction is conducted at 250° C. to 310° C. The reaction is usually conducted in an inert gas atmosphere under vacuum and/or an atmospheric pressure and/or a maximum pressure of 20 bar. 0.6 mol to 1.5 mol of the aliphatic amino acid or lactam is used per mol of the TPA, the IPA, or the mixture of TPA and IPA.

During the reaction in step 2, a catalyst such as phosphoric acid or hypophosphorous acid is usually used. During the reaction in this step, TPA and/or IPA are/is supplemented as needed. In general, a molar amount of TPA is 50% or less of a total amount of TPA and IPA. In addition, during the reaction in step 2, additives such as a light stabilizer, a stabilizer, a plasticizer, and a mold release agent may be added.

As an embodiment of the present disclosure, the multilayer polymer sheet has a total thickness of 400 μm to 1500 μm, where the B-layer polymer has a thickness of 50 μm to 1,000 μm, preferably 100 μm to 800 μm, and more preferably 150 μm to 500 μm.

As an embodiment of the present disclosure, the A-layer polymer is resistant to corrosion of ethanol.

As an embodiment of the present disclosure, the multilayer polymer sheet has a tensile modulus of greater than 800 MPa and preferably greater than 1,000 MPa. In some embodiments, the multilayer polymer sheet has a tensile modulus of 800 MPa to 4,500 MPa and preferably 1,000 MPa to 4,500 MPa.

As an embodiment of the present disclosure, the TPU is a polyether or polyester based PU, and has a shore hardness range of 40 D to 85 D.

As an embodiment of the present disclosure, the multilayer polymer sheet is prepared through co-extrusion or extruded lamination. In some embodiments, the A-layer polymer and the B-layer polymer each are extrusion-molded and then laminated to form a multilayer structure, obtaining the multilayer polymer sheet. A distributor may be used to conduct co-extrusion or in-mold co-extrusion, and preferably, the in-mold co-extrusion is conducted for lamination.

The present disclosure also relates to a dental appliance made of the multilayer polymer sheet described above, where the dental appliance is conformal to one or more teeth.

Compared with the prior art, the present disclosure has the following benefits:
1) A multilayer material based on the specially-modified PA material of the present disclosure exhibits excellent stress retention performance and abrasion resistance.
2) A multilayer material based on the specially-modified PA material of the present disclosure has a low surface friction coefficient, which is conducive to the wearing and removal of an orthodontic appliance and provides a prominent orthodontic effect and wearing experience overall.
3) A multilayer material based on the specially-modified PA material of the present disclosure has better flexibility and orthodontic devices made from it is easier to be worn and removed than that made from single-layer polymer sheet.
4) A multilayer material based on the specially-modified PA material of the present disclosure is resistant to corrosion of ethanol, so the appliance made of the multilayer material can be disinfected with medical alcohol, which is beneficial to the health of users.

### BRIEF DESCRIPTION OF THE DRAWINGS

Other features, objectives, and advantages of the present disclosure will become more apparent by reading the detailed description of non-limiting embodiments with reference to the following accompanying drawings.

FIG. 1 shows test results of stress retention performance of single-layer products;

FIG. 2 shows test results of stress retention performance of comparative examples; and

FIG. 3 shows test results of stress retention performance of examples.

### DETAILED DESCRIPTION OF THE EMBODIMENTS

The present disclosure is described in detail below with reference to examples. The following examples will help those skilled in the art to further understand the present disclosure, but do not limit the present disclosure in any way. It should be noted that those of ordinary skill in the art can further make several modifications and improvements without departing from the idea of the present disclosure. These all fall within the protection scope of the present disclosure.

Compositions of modified PAs EPA-1 and EPA-2 involved in the following examples are as follows:
(1) EPA-1: 48.2 kg of 4,4-methylenebis(2-methylcyclohexylamine) (molecular weight: 238.42), 17.0 kg of TPA (molecular weight: 166.131), 17.0 kg of IPA (molecular weight: 166.131), 28.8 kg of dodecalactam (molecular weight: 197.317), 30 kg of deionized water, and 11 g of hypophosphorous acid (50% solution). The above substances were pre-mixed in a vessel, and a resulting mixture was passivated with nitrogen, then heated to 230° C., then transferred to a reaction vessel, heated to 295° C. under stirring, and kept at 20 bar for 4 h; the pressure was then reduced to an atmospheric pressure, and exhaust was conducted; a resulting melt was allowed to flow out to a water bath and cooled, and granulation was conducted while cooling; and resulting particles were dehumidified and dried until a moisture content was lower than 0.05%, and then could be used for extrusion to produce a sheet. At 20° C., a viscosity of dried particles in a 0.5% m-cresol solution was 1.52.
(2) EPA-2: 48.2 kg of 4,4-methylenebis(2-methylcyclohexylamine) (molecular weight: 238.42), 34.0 kg of IPA (molecular weight: 166.131), 23.2 kg of 1,8-aminooctanoic acid (molecular weight: 159.226), 25 kg of deionized water, and 8 g of hypophosphorous acid (50% solution). Reaction conditions of EPA-2 were consistent with the reaction conditions of EPA-1. Resulting particles needed to be dehumidified and dried until a moisture content was lower than 0.05%, and then could be used for extrusion to produce a sheet. At 20° C., a viscosity of dried particles in a 0.5% m-cresol solution was 1.46.

Multilayer polymer sheets of the examples and comparative examples were prepared through co-extrusion, and a specific process was as follows: pellets of A-layer polymer and pellets of B-layer polymer were firstly dehumidified and dried for 8 hours or more to achieve moisture content of lower than 0.05%; and then the two pellets were fed into two separate extruders and subjected to extrusion molding. Melts of the A-layer polymer and B-layer polymer were laminated directly inside the die to form a multilayer structure, which was cooled and shaped by a set of shaping rollers to required thickness.

| | Component | | |
|---|---|---|---|
| No. | Layer A (0.25 mm) | Layer B (0.25 mm) | Layer A (0.25 mm) |
| Example 1 | Modified PA EPA-1 | PU Pellethane 8663- | Modified PA EPA-1 |
| | (water absorption rate: | 55D | |
| | 2.5%, Shore hardness: 80 D) | Shore hardness: 51 D | |
| Example 2 | Modified PA EPA-2 | EVA copolymer Ateva | Modified PA EPA-2 |
| | (water absorption rate: | 1801G | |
| | 3%, Shore hardness: 78 D) | | |
| Example 3 | Amorphous PA Arkema | PU Texin RxT 50D | Amorphous PA |
| | Rilsan G135, Shore | Shore hardness: 50 D | Arkema Rilsan G350 |
| | hardness: 78 D | | |
| Example 4 | Amorphous PA EMS | Pellethane 8663-95A | Amorphous PA EMS |
| | Grilamid TR 55, Shore | Shore hardness: 95 A | Grilamid TR 55 |
| | hardness: 85 D | | |
| Example 5 | Modified PA EPA-1 | Copolyester Tritan MX | Modified PA EPA-1 |
| | (water absorption rate: | 710, Shore hardness: 87 D | |
| | 2.5%, Shore hardness: 80 D) | | |
| Comparative | PU Isoplast 2530 81D | PU Texin RxT 50D | PU Isoplast 2530 |
| Example 1 | | Shore hardness: 50 D | |
| Comparative | Micro-crystalline PA | PU Elastollan 1185A | Micro-crystalline PA |
| Example 2 | Trogamide CX7323, | Shore hardness: 85 A | Trogamide CX7323 |
| | Shore hardness: 81 D | | |
| Comparative | Copolyester Tritan MX | PU Elastollan 1195A | Copolyester Tritan |
| Example 3 | 710, Shore hardness: 87 D | Shore hardness: 95 A | MX 710 |
| Comparative | Micro-crystalline PA | PU Pellethane 8663-55D | Micro-crystalline PA |
| Example 4 | Trogamide CX7323, | Shore hardness: 51 D | Trogamide CX7323 |
| | Shore hardness: 81 D | | |
| Comparative | Micro-crystalline PA | EVA copolymer Ateva | Micro-crystalline PA |
| Example 5 | Trogamide CX7323, | 1801G | Trogamide CX7323 |
| | Shore hardness: 81 D | | |

| | |
|---|---|
| Single-layer | Modified PA EPA-1 (0.75 mm), 80 D |
| product 1 | |
| Single-layer | Micro-crystalline PA Trogamide CX7323 (0.75 mm), 81 D |
| product 2 | |
| Single-layer | PU Isoplast 2530 (0.75 mm), 84 D |
| product 3 | |
| Single-layer | Amorphous PA Arkema Rilsan G120 Rnew |
| product 4 | |
| Single-layer | Amorphous PA EMS Grilamid TR 55 |
| product 5 | |

Performance test results were shown in Table 2 below:

TABLE 2

| | Comparative Examples | | | | | Examples | | | | | Single-layer products | | | | |
|---|---|---|---|---|---|---|---|---|---|---|---|---|---|---|---|
| | 1 | 2 | 3 | 4 | 5 | 1 | 2 | 3 | 4 | 5 | 1 | 2 | 3 | 4 | 5 |
| Tensile | 1051 | 724 | 1067 | 933 | 878 | 1105 | 1019 | 1112 | 1385 | 1590 | 1946 | 1400 | 2226 | 1480 | 2200 |
| modulus, | | | | | | | | | | | | | | | |
| (Mpa) | | | | | | | | | | | | | | | |
| Flexural | 1419 | 1067 | 1395 | 1080 | 1012 | 1633 | 1421 | 1260 | 1522 | 1720 | 1673 | 1700 | 2409 | 1340 | 1980 |
| modulus, | | | | | | | | | | | | | | | |
| (Mpa) | | | | | | | | | | | | | | | |
| Tear | 179.12 | 159.4 | 133 | 183.2 | 174.3 | 182.2 | 171.3 | 177.6 | 180.1 | 219.7 | 227 | 198 | 220.6 | 189 | 214.7 |
| strength | | | | | | | | | | | | | | | |
| (KN/m) | | | | | | | | | | | | | | | |
| Abrasion | 15 | 18 | 140 | 18 | 18 | 12 | 10 | 16 | 8 | 10 | 12 | 18 | 15 | 12 | 8 |
| resistance | | | | | | | | | | | | | | | |
| ((1,000 r, | | | | | | | | | | | | | | | |
| CS10)/ | | | | | | | | | | | | | | | |
| mg) | | | | | | | | | | | | | | | |
| 24 h | 18* | 46 | 65 | 49 | 42 | 78 | 74 | 62 | 55 | 71 | 72 | 38 | 33 | 58 | 52 |
| Stress | | | | | | | | | | | | | | | |
| retention | | | | | | | | | | | | | | | |
| ratio (%) | | | | | | | | | | | | | | | |
| Ethanol | Good | Poor | Good | Poor | Poor | Good | Good | Poor | Poor | Good | Good | Poor | Good | Poor | Poor |
| resistance | | | | | | | | | | | | | | | |

*For comparative Example 1, the tensile stress decreased quickly and severely, and only a 6 hours of stress degradation was tested.

The tensile modulus was tested according to “GB/T 1040.3-2006 Determination of Tensile Properties of Plastics”, where a tensile speed of a device was set to 50 mm/min; and type-5 samples were used.

The flexural modulus of was tested by according to “GB/T 9341-2008 Determination of Flexural Properties of Plastics”.

The tear strength was tested according to protocol (a) of method B in “GB/T 529-2008 Determination of Tear Strength of Vulcanized Rubber or Thermoplastic Rubber”, where a sample was prepared according to 5.1.2 in the standard, adapting actual thickness of the sample and with stretching speed of 500±50 mm/min.

The abrasion resistance of sheet material was tested according to “GB/T 5478-2008 Test Method of Rolling Wear of plastics”, where a CS10 wearing wheel was used to measure the value after 1,000 cycles of abrasion.

The stress retention performance was tested as follows: The same stripes as used in tensile modulus test were taken. The stripe sample was stretched to a strain of 101.5% and maintained for 24 hours. An attenuation curve of a tensile force on the stripe sample during this period of time was recorded. The above test was conducted in a 37° C. water bath.

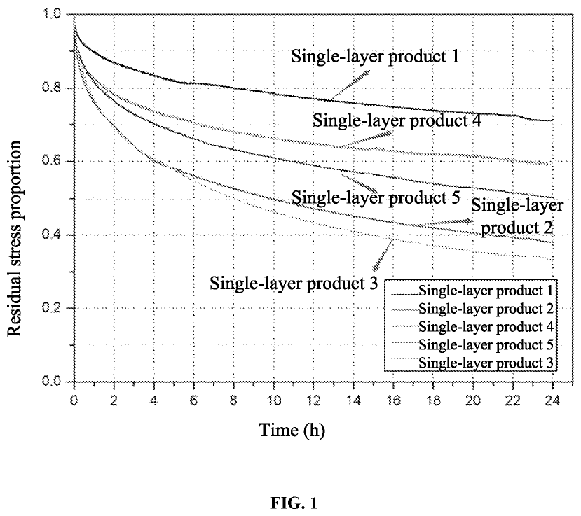

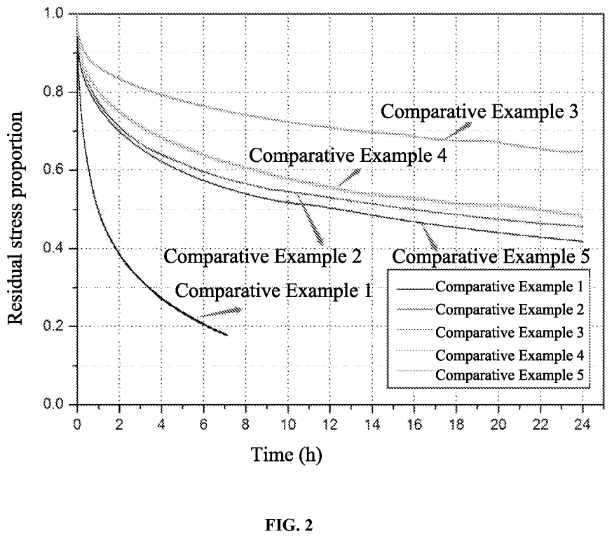

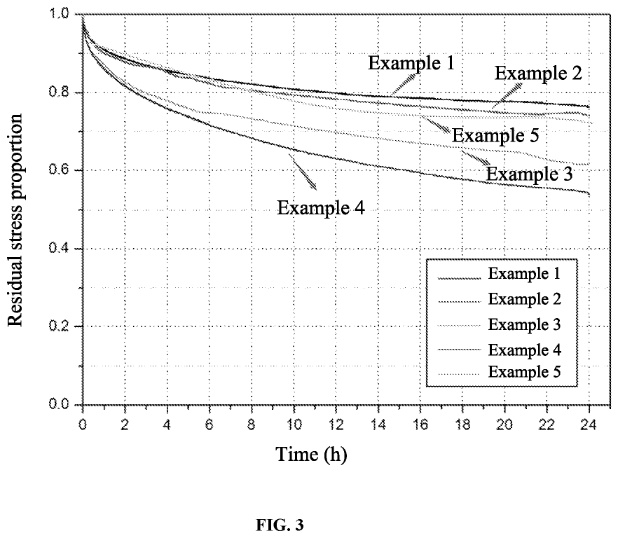

FIG. 1, FIG. 2, and FIG. 3 are contrast schematic diagrams of stress retention ratios of examples, comparative examples, and single-layer samples, respectively; and Comparative Examples 1, 2, and 3 are similar examples in patent U.S. Pat. No. 10,549,511B2. Table 1 shows the structural composition of the material in each comparative example. In Comparative Example 1, a triple-layer PU structure was adopted, where the surface layers are hard PU and the inner layer is soft PU. FIG. 2 shows test results of stress degradation of materials, and it can be seen from FIG. 2 that the material in Comparative Example 1 undergoes severe stress degradation, and just 6 hours later, the residual stress is only 18% of its initial stress. The single-layer product 3 was made of the hard PU same with the outer layer of Comparative Example 1, and it can be seen from FIG. 1 that this material itself undergoes severe stress degradation, and when this material is used to prepare a multilayer material, the stress degradation is further deteriorated.

Triple-layer sheets were prepared with a micro-crystalline polyamide material in Comparative Examples 2, 4, and 5 separately, and single-layer product 2 was also prepared from the same micro-crystalline polyamide. Different materials were used for the intermediate layers in Comparative Examples 2, 4, and 5. It can be seen from FIG. 2 that the single-layer micro-crystalline PA sheet undergoes severe stress degradation, and after 24 h stress degradation test, the residual stress inside the polymer sheet is only 38% of the initial stress. The stress degradation of the triple-layer sheets in Comparative Examples 2, 4, and 5 is slightly lower than that of single-layer product 2, and after 24 h stress degradation test, residual stress of the three sheets were 46%, 49%, and 42% of their initial stress respectively. Despite what kind of intermediate polymers used, there seems to be no difference of their stress retention performance. A micro-crystalline PA molecular chain has no branched chain, and the molecular chain structure is regular, which facilitates crystallization. However, due to a small crystalline region, the micro-crystalline PA does not affect the transparency of a material. Therefore, the micro-crystalline PA can be used in production of an invisible orthodontic appliance. Studies of the micro-crystalline PA by inventors show that the stress degradation of this material is relatively fast, which is similar to that of hard PU (such as the single-layer product 3). It is speculated that the presence of micro-crystalline region leads to fast stress degradation. In addition, this micro-crystalline PA is not resistant to ethanol, therefore it cannot be disinfected with 75% ethanol solution, which is not conducive to the disinfection for a wearer.

A triple-layer sheet was prepared with a copolyester in Comparative Example 3. It can be seen from FIG. 2 that the sheet in this example undergoes small stress degradation, after a 24 h stress degradation test, the residual stress of the sheet in Comparative Example 3 is 65% of its initial stress It should be noted that the copolyester material has poor abrasion resistance performance. Table 2 shows that abrasion value of this material under Taber wear test is significantly higher than that of other samples and high wear value usually means that the material is susceptible to worn out and crack during use. Moreover, under continuous stress, the material is prone to crazes, resulting in the failure of mechanical performance of the material. These two drawbacks may affect the progress of orthodontic treatment.

In Examples 1 and 2, modified polyamide EPA-1 and EPA-2 were used to prepare triple-layer sheets. It can be seen from FIG. 3 that the triple-layer sheets prepared in the two examples undergo very small stress degradation; and after a 24 h stress degradation test, residual stress of the sheets in Examples 1 and 2 are 78% and 74% of their initial stress, respectively. A single-layer sheet made of the modified polyamide EPA-1 undergoes relatively small stress degradation, and after a 24 h stress degradation test, the residual stress in the EPA-1 single-layer sheet is 72% of its initial stress.

In Examples 3 and 4, two commercially available amorphous PAs were used to prepare multilayer sheets. The single-layer product 4 and the single-layer product 5, were prepared from the same two amorphous PAs respectively. After a 24 h stress degradation test, residual stress in the two sheets of Examples 3 and 4 are 62% and 55% of their initial stress, respectively; and after a 24 h stress degradation test, residual stress in the corresponding single-layer product 4 and single-layer product 5 are 58% and 52% of their initial stress, respectively. The stress degradation of the two commercially available amorphous PAs is more severe than that of Examples 1 and 2, but both are better than that of Comparative Examples 2, 4, and 5.

In Example 5, a multilayer sheet was prepared through co-extrusion of the modified PA EPA-1 and the copolyester Tritan MX710. It can be seen from FIG. 3 that this combined sheet showed excellent stress retention performance; and after a 24 h stress degradation test, the residual stress in the sheet of Example 5 is 71% of its initial stress. As EPA-1 and Tritan MX710 both have high hardness, the polymer sheet of Example 5 feels hard and is less comfortable than sheets in other examples. However, these two polymers have similar processing temperatures, which brings convenience to production and processing, allows a stable production process, and is cost effective.

In summary, the sheets in the examples of the present disclosure have low stress degradation rate and superior abrasion resistance, and are ideal sheets for orthodontic appliances.

The specific examples of the present disclosure are described above. It should be understood that the present disclosure is not limited to the above specific implementations, and a person skilled in the art can make various variations or modifications within the scope of the claims without affecting the essence of the present disclosure.

What is claimed is:

1. A multilayer polymer sheet, comprising an A-layer polymer and a B-layer polymer, wherein
the A-layer polymer is an amorphous polyamide (PA);
the B-layer polymer is at least one selected from the group consisting of a thermoplastic polyurethane (TPU), an ethylene-vinyl acetate (EVA) copolymer, and a copolyester, and
the B-layer polymer is located between two layers of the A-layer polymer.

2. The multilayer polymer sheet according to claim 1, wherein the amorphous PA has a shore hardness range of 45 D to 87 D.

3. The multilayer polymer sheet according to claim 1, wherein a structural unit of the A-layer polymer comprises 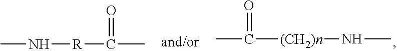
wherein R is a C₅-C₃₅ branched or cycloaliphatic hydrocarbon and n is 4 to 11.

4. The multilayer polymer sheet according to claim 1, wherein the A-layer polymer is obtained through a polymerization of the following substances: (1) 4,4-methylenebis(2-methylcyclohexylamine); (2) an aromatic dicarboxylic acid; and (3) an alicyclic or aliphatic amino acid or lactam; wherein the aromatic dicarboxylic acid is 1,3-benzenedicarboxylic acid (IPA) and/or 1,4-benzenedicarboxylic acid (TPA).

5. The multilayer polymer sheet according to claim 4, wherein the aromatic dicarboxylic acid is a mixture of the IPA and the TPA, and an amount of the TPA is 50% or less of a total amount of the aromatic dicarboxylic acid.

6. The multilayer polymer sheet according to claim 1, wherein the A-layer polymer has a relative viscosity of greater than 1.45, and the relative viscosity is tested in a 0.5% m-cresol solution at 20° C. according to an ISO 307 standard.

7. The multilayer polymer sheet according to claim 1, wherein the multilayer polymer sheet has a total thickness of 400 μm to 1,500 μm and a tensile modulus of greater than 800 MPa.

8. The multilayer polymer sheet according to claim 1, wherein the TPU is a polyether or polyester based polyurethane (PU), and the TPU has a Shore hardness range of 40 D to 85 D.

9. A preparation method of the multilayer polymer sheet according to claim 1, comprising laminating the A-layer polymer and the B-layer polymer through a in-mold co-extrusion to obtain the multilayer polymer sheet.

10. A dental appliance made of the multilayer polymer sheet according to claim 1, wherein the dental appliance is conformal to one or more teeth.

11. The preparation method according to claim 9, wherein the amorphous PA has a shore hardness range of 45 D to 87 D.

12. The preparation method according to claim 9, wherein a structural unit of the A-layer polymer comprises 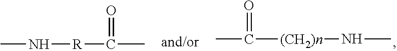
wherein R is a C₅-C₃₅ branched or cycloaliphatic hydrocarbon and n is 4 to 11.

13. The preparation method according to claim 9, wherein the A-layer polymer is obtained through a polymerization of the following substances: (1) 4,4-methylenebis(2-methylcyclohexylamine): (2) an aromatic dicarboxylic acid; and (3) an alicyclic or aliphatic amino acid or lactam; wherein the aromatic dicarboxylic acid is 1,3-benzenedicarboxylic acid (IPA) and/or 1,4-benzenedicarboxylic acid (TPA).

14. The preparation method according to claim 13, wherein the aromatic dicarboxylic acid is a mixture of the IPA and the TPA, and an amount of the TPA is 50% or less of a total amount of the aromatic dicarboxylic acid.

15. The preparation method according to claim 9, wherein the A-layer polymer has a relative viscosity of greater than 1.45, and the relative viscosity is tested in a 0.5% m-cresol solution at 20° C. according to an ISO 307 standard.

16. The preparation method according to claim 9, wherein the multilayer polymer sheet has a total thickness of 400 μm to 1,500 μm and a tensile modulus of greater than 800 MPa.

17. The preparation method according to claim 9, wherein the TPU is a polyether or polyester based polyurethane (PU), and the TPU has a Shore hardness range of 40 D to 85 D.

18. The dental appliance according to claim 10, wherein the amorphous PA has a shore hardness range of 45 D to 87 D.

19. The dental appliance according to claim 10, wherein a structural unit of the A-layer polymer comprises 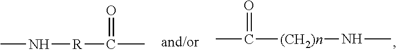
wherein R is a C₅-C₃₅ branched or cycloaliphatic hydrocarbon and n is 4 to 11.

20. The dental appliance according to claim 10, wherein the A-layer polymer is obtained through a polymerization of the following substances: (1) 4,4-methylenebis(2-methylcyclohexylamine); (2) an aromatic dicarboxylic acid; and (3) an alicyclic or aliphatic amino acid or lactam; wherein the aromatic dicarboxylic acid is 1,3-benzenedicarboxylic acid (IPA) and/or 1,4-benzenedicarboxylic acid (TPA).
